(19) United States
(12) Patent Application Publication
(10) Pub. No.: US 2004/0206828 A1
(43) Pub. Date: Oct. 21, 2004

(54) Identification devices for infant articles and methods thereof

(76) Inventor: Byron Wesley Harris, North Las Vegas, NV (US)

Correspondence Address: Dr. David Landman, #126, 3320 S. Fort Apache Rd., Las Vegas, NV, 89117, US

(21) Appl. No.: 10/643,415

(22) Filed: Aug. 20, 2003

Related U.S. Application Data
(60) Provisional application No. 60/463,502, filed on Apr. 18, 2003.

(51) Int. Cl. G06K 19/00

(52) U.S. Cl. 235/487

(57) ABSTRACT

An identification device for an infant comprises a receiver member having a recess for receiving a label. A tightly fitting retainer encloses the label in the recess of the receiver member. The label comprises visual information to identify the infant, including the infant's name, address, parent's names, and current history of immunizations, medications and emergency telephone numbers, a photograph of the infant, a finger print and a toe print. The information may also be embedded in electronic form or as bar coded data coupled to the identification device. The identification device may be coupled to a portion of an infant's body including an arm or a leg and to an infant's possession's including drink and eating containers, apparel, foot wear, cribs and strollers.

### CROSS-REFERENCE TO RELATED APPLICATION

This application claims priority of U.S. Provisional Application No. 60/463,502, filed Apr. 18, 2003, entitled: Baby Bottle Identification Clip by Byron Wesley Harris.

### FIELD OF THE INVENTION

This invention relates generally to identification devices and methods for babies, and more particularly to identification devices for infant articles and methods thereof.

### BACKGROUND OF THE INVENTION

In the past, numerous methods and devices have been suggested and used to provide identification for people with special needs. People of particular interest that are in this category include infants and babies. Various types of identifiers for infants have included labels or tags sewn to the apparel of the infant with their pertinent information listed on the label or tag. Other devices have included bracelets worn on the wrist or ankle of the infant.

Kraus, U.S. Pat. No. 6,510,988 disclosed an identification bracelet suitable for use by various people with special needs. The bracelet consisted of an identification tag built into a wearer resistant squeeze-and-turn buckle. Information about a wearer of such a buckle is typically accessed by means of a computerized system. Therefore, in Kraus, U.S. Pat. No. 6,510,988 immediate person identification and special needs are highly dependent on non-visual methods and one's ability to access the computer system.

Ricks, U.S. Pat. No. 4,759,139 disclosed an identification collar for a baby bottle. In Ricks, U.S. Pat. No. 4,759,139 a removable collar is placed over the neck of a bottle and the collar is enclosed in place by a standard nipple cap. A flange provided on the collar receives a gummed label protected by a raised ridge of a portion of the flange.

As disclosed by Ricks, U.S. Pat. No. 4,759,139 with the prevalent use of day care centers, there is a need for quickly and easily associating infant's articles (Ricks, U.S. Pat. No. 4,759,139 specifies the articles are baby bottles) with a particular infant. Standard methods that are currently used include placing masking tape or a gummed label on an article and writing particulars about the infant (usually only the infant's name) on the tape or the label. Alternatively, a marking pen is used to write information and identify the infant. Often the ink used in such applications may be thought of as being somewhat toxic to the infant, even though ink manufacturers may be careful to formulate relatively non-toxic inks. Articles labeled in these ways may not be easily cleaned without destroying the information that is attached to the article. Moreover, information written by hand on a label may be illegible to others, especially when a great deal of information is required on a relatively small label area.

For the foregoing reasons, there is a need to provide improved identification devices for baby articles and methods thereof which overcome the difficulties mentioned above.

### SUMMARY OF THE INVENTION

Accordingly, it is an object of this invention to provide improved identification devices for infant articles.

It is a further object of this invention to provide improved adult removable identification devices for infant articles.

It is yet a still further object of this invention to provide improved methods for using identifier devices for infant articles.

### PREFERRED EMBODIMENTS OF THE INVENTION

In accordance with one embodiment of this invention, an identification device for an infant is disclosed. The identification device comprises, in combination an infant article; a label including personal information of the infant coupled to a portion of the identification device; and means for coupling at least a portion of the identification device to the infant article. The identification device further comprises a member. In one example, the means for coupling at least a portion of the identification device comprises a pair of ends of the member; each one of the ends is coupled to a portion of the infant article. A portion of a surface of the member has a recess for receiving the label. A retainer is coupled to the recess of the member for enclosing the label in the recess. In one example, the member is curved and each one of the pair of ends is coupled to a portion of the infant article.

Alternatively, the means for coupling the identification article comprises an adhesive. A portion of the member is adhesively coupled to a portion of the infant article. A portion of the member has a multiplicity of openings for selectively receiving an end of a strap so that the strap is coupled to the infant article when the end of the strap is coupled to an opposite end of the strap. In one example, the strap of the identification device is coupled to the infant.

The label is coupled to a portion of a surface of the recess. Alternatively, the label is coupled to a portion of a surface of the retainer. A portion of a side of the label comprises a visible identifier selected from the group consisting of at least a name of an infant, at least a photograph, at least a finger print and at least a toe print. A portion of an opposite side of the label comprises at least a visible list of personal information of the infant selected from the group consisting of an infant's name, at least an infant's address, at least a parent's name, a current history of immunizations, at least a medication, at least an emergency telephone number, at least a photograph, at least a finger print and at least a toe print. At least a portion of the identification device comprises an identifier selected from the group consisting of a programmable semi-conductor chip, a digital data recording device, a radio frequency identification device and a barcode. The identification device comprises transparent plastic.

In accordance with a second embodiment of this invention, an integral identification device for an infant is disclosed. The integral identification device comprises, in combination an infant article; a label coupled to a portion of the identification device for providing personal information of the infant; the identification device comprising an identification portion of the infant article. The identification portion of the infant article has a recess for receiving a label. A retainer is coupled to the recess of the identification portion of the infant article for enclosing the label in the recess. The label comprises a visible identifier of the infant selected from the group consisting of an infant's name, at least an infant's address, at least a parent's name, a current history of immunizations, at least a medication, at least an emergency telephone number, at least a photograph, at least a finger print and at least a toe print. At least a portion of the identification device comprises an identifier selected from the group consisting of a programmable semi-conductor chip, a digital data recording device, a radio frequency identification device and a barcode.

In accordance with a third embodiment of this invention, a method for using an identifier device for an infant is disclosed. The method comprises the steps of providing an infant article; coupling a label including personal information of the infant to a portion of the identification device; and providing means for coupling at least a portion of the identification device to the infant article. The method further comprises providing a member; providing the means for coupling at least a portion of the identification device comprises a pair of ends of the member, each one of the ends coupled to a portion of the infant article; providing the means for coupling at least a portion of the identification device comprises an adhesive, a portion of the member adhesively coupled to a portion of the infant article; providing a portion of a surface of the member having a recess for receiving the label; coupling a retainer to the recess of the member for enclosing the label in the recess; and providing a portion of the member having a multiplicity of openings for selectively receiving an end of a strap so that the strap is coupled to the infant article when the end of the strap is coupled to an opposite end of the strap. The method further comprises providing a portion of a side of the label comprises a visible identifier selected from the group consisting of at least a name of an infant, at least a photograph, at least a finger print and at least a toe print; providing a portion of an opposite side of the label comprises at least a visible list of personal information of the infant selected from the group consisting of an infant's name, at least an infant's address, at least a parent's name, a current history of immunizations, at least a medication, at least an emergency telephone number, at least a photograph, at least a finger print and at least a toe print; and providing at least a portion of the identification device comprises an identifier selected from the group consisting of a programmable semi-conductor chip, a digital data recording device, a radio frequency identification device and a barcode.

The foregoing and other objects, features, and advantages of the invention will be apparent from the following, more detailed description of the preferred embodiments of the invention, as illustrated in the accompanying drawings.

### BRIEF DESCRIPTION OF THE DRAWINGS

FIG. 1 is a perspective view of one example of an identification device for infants, in accordance with this invention;

FIG. 1A is an elevation view of a top portion of the identification device of FIG. 1 with a retainer loosely coupled to a portion of a recess of the identification device of FIG. 1;

FIG. 1B is a perspective view of the identification device of FIG. 1 showing the retainer loosely coupled to the portion of the recess of the identification device of FIG. 1;

FIG. 2 is an elevation view of a side of a label enclosed in the recess by the retainer of the identification device of FIG. 1;

FIG. 2A is an elevation view of a reverse side of the label enclosed in the recess by the retainer of the identification device of FIG. 1;

FIG. 2B is an elevation view of a second example of a reverse side of the label enclosed in the recess by the retainer of the identification device of FIG. 1;

FIG. 3 is a perspective view of a portion of an infant's arm showing a strap coupled to the identification device of FIG. 1 around an infant's wrist;

FIG. 3A is a perspective view of the strap of FIG. 3;

FIG. 3B is a perspective view showing a front portion of the identification device of FIG. 1 that is coupled to the strap of FIG. 3A around the infant's wrist;

FIG. 4 is an elevation view of the identification device of FIG. 1 coupled to a portion of a container;

FIG. 5 is an elevation view of a second example of an identification device coupled to a portion of a container;

FIG. 5A is a perspective view of the second example of the identification device of FIG. 5 coupled to the portion of the container; and

FIG. 6 is a perspective view of a third example of an identification device coupled to a portion of an apparel article.

### DESCRIPTION OF THE INVENTION

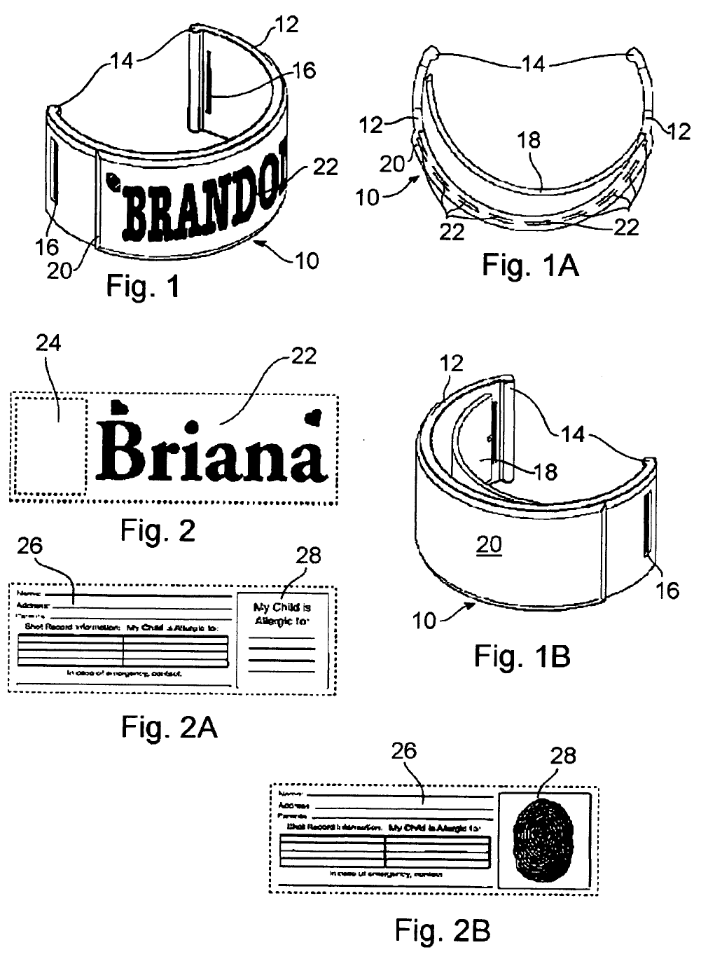

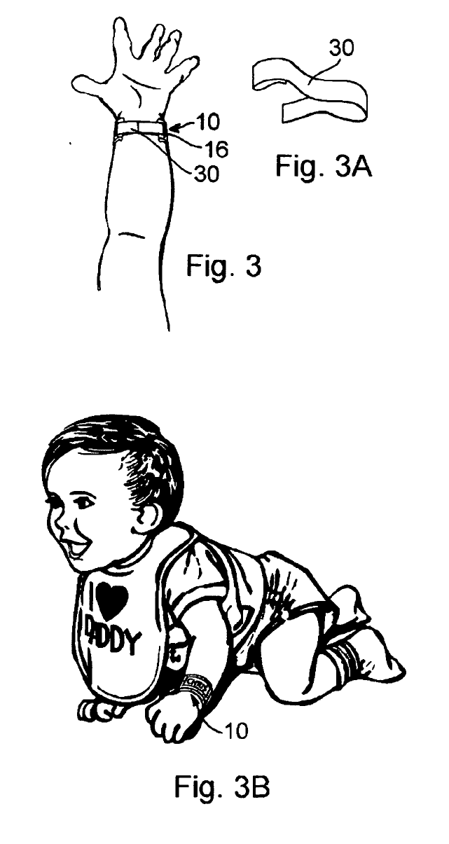

In a first example of an identification device 10 according to FIG. 1, the identification device 10 comprises a curved member 12 having a pair of ends 14. The curved member 12 is essentially U-shape. A portion of each one of the ends 14 of the curved member 12 protrudes into the U-shape portion of the curved member 12. A portion of an inner surface of the curved member 12 defines a recess for receiving a label 22. A tightly fitting retainer 18 (see FIG. 2) encloses the label 22 in the recess of the curved member 12. An elevated portion 20 of the surface of the curved member 12 is proximate to the recess and may provide optical magnification of the image of the label 22. A portion of the surface of the curved member 12 defines a multiplicity of openings 16 for receiving a strap 30 (see FIG. 3A).

Referring to FIGS. 1A and 1B, the label 22 is coupled to a portion of the recess of the curved member 12 and to the retainer 18. Alternatively, the label 22 may be pre-coupled to the retainer 18 using a pressure sensitive adhesive. The retainer 18 is tightly coupled to the recess. The recess is preferably narrower than the width of the curved member 12. The retainer 18 is preferably a flexible material such as a plastic and is preferably transparent to allow information on a portion of a surface of a reverse side 26 of the label 22 (see FIGS. 2A and 2B) to be read. The retainer 18 is coupled to the recess of the curved member 12 by sliding an end of the retainer 18 into an end of the recess and bending the retainer 18 until an opposite end of the retainer 18 couples to an opposite end of the recess. When the retainer 18 is coupled to the recess, the retainer 18 completely covers the recess, so as to provide little opportunity for fluid accumulation in the recess of the curved member 12. This feature protects a fragile label 22 from destruction by fluids, with resulting loss of information residing on the label 22.

According to FIGS. 1, 2, 2A, 2B a portion of a surface of a first side of the label 22 comprises an infant's name. In FIG. 2, one portion 24 of the surface of the first side of the label 22 may comprise a photograph of the infant for further identification, as well as the infant's name. The one portion 24 of the surface of the first side of the label 22 may also comprise other indicia such as a thumb print or a toe print of the infant. FIGS. 2A and 2B show alternative identification information on a portion of a surface of the reverse side 26 of the label 22. The information on the portion of the surface of the reverse side 26 of the label 22 may include the name, address, parent's names, and current history of immunizations, medications and emergency telephone numbers. Another portion 28 of the surface of the reverse side 26 of the label 22 (see FIGS. 2A and 2B) may comprise other indicia such as a list of items that are allergic for the infant, a thumb print and a toe print. The label 22 may comprise any printable medium including paper, metal and plastic. The label 22 may also be laminated to protect the information context of the label 22 from destruction by fluids. A portion of the surface of the label 22 may also comprise a programmable semi-conductor chip, a digital data recording device, a radio frequency identification device or a barcode that are encoded with the infant's identifying information. A programmable semi-conductor chip, a digital data recording device, a radio frequency identification device or a barcode that are encoded with the infant's identifying information may also be coupled to other portions of the identification device 10.

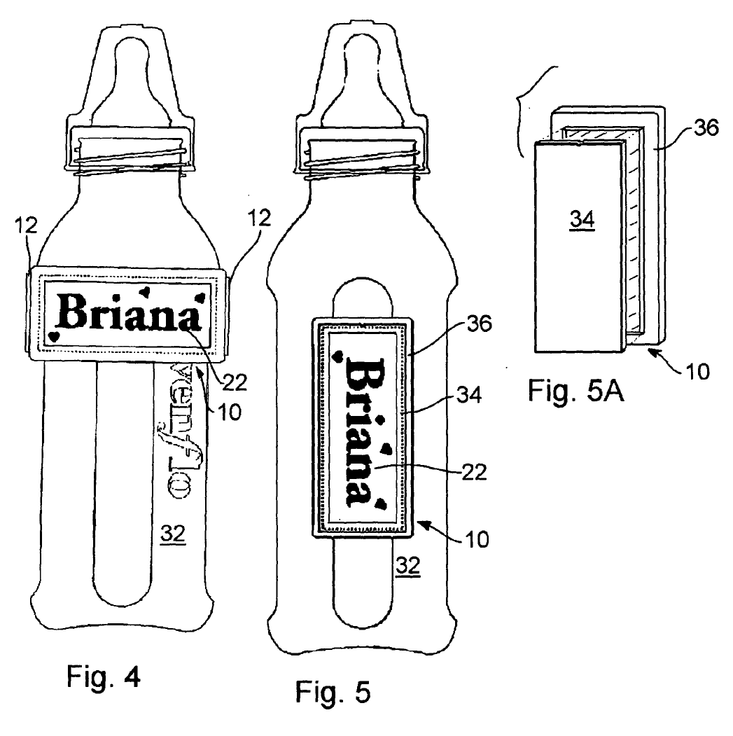

FIG. 3 is a perspective view of a portion of an infant's arm showing a strap 30 coupled to the identification device 10 around an infant's wrist. An end of the strap 30 passes through the slot 16 in a portion of a first end of the curved member 12 and an opposite end of the strap 30 passes through the slot 16 in a portion of second end of the curved member 12 so that the identification device 10 is essentially circularly shaped when the end of the strap 30 and the opposite end of the strap 30 are coupled. Coupling of the end of the strap 30 and the opposite end of the strap 30 is preferably achieved by using VELCRO® (VELCRO INDUSTRIES B.V.). Alternatively, a pressure-sensitive adhesive, clips or buttons may be used to couple the end of the strap 30 to the opposite end of the strap 30. FIG. 3A is a perspective view of the strap 30. FIG. 3B is a perspective view showing a front portion of the identification device 10 coupled to the strap 30 around the infant's wrist. As illustrated in FIGS. 3, 3A and 3B the identification device 10 coupled to the strap 30 is used as a bracelet for identifying the infant. The identification device 10 of FIGS. 1, 1A and 1B has multiple uses (see FIG. 4) that do not require the strap 30 to form a bracelet.

Referring to FIG. 4, the identification device 10 is coupled to a portion of a container 32. Each one of the ends 14 reversibly couples to a portion of the container 32. The curved member 12 preferably comprises a flexible plastic that conforms to the portion of the container 32 when the identification device 10 is coupled by tension to the container 32. The identification device 10 is removable from the container 32. Alternatively, the identification device 10 may be coupled to the container 32 by using a pressure sensitive adhesive. In addition, the identification device 10 may be coupled to the container 32 by using the strap 30 as described above for coupling the identification device 10 to an infant's arm. The strap 30 comprises a plastic, a metal or a rubber. In FIG. 4, the container 32 is illustrated as a baby feeding bottle. The identification device 10 may be coupled to other containers such as a drinking cup or a bowl.

According to FIGS. 5 and 5A, a second example of an identification device 10 comprises a receiver member 36. A portion of a surface of the receiver member 36 defines a recess for receiving a label 22. A retainer 34 encloses the label 22 in the recess of the receiver member 36. The retainer 34 is tightly coupled to the receiver member 36 to prevent a fragile label 22 from destruction by fluids, with resulting loss of information residing on the label 22. In addition, the tight coupling of the retainer 34 to the receiver member 36 prevents an infant from readily decoupling the retainer 34 from the receiver member 36, which could result in loss of the label 22. As discussed above the label 22 comprises information such as the infant's name, address, parent's names, and current history of immunizations, medications, emergency telephone numbers, a photograph of the infant and a finger print or a toe print. The retainer 34 and the receiver member 36 preferably comprise a transparent plastic. Referring to FIG. 5 a portion of the receiver member 36 is coupled to a portion of a surface of a container 32. The receiver member 36 may be molded as part of the container 32. Alternatively the receiver member 36 may be adhered to the portion of the surface of the container 32 using a welding process or an adhesive. Suitable adhesives comprise thermosetting, thermoplastic and pressure sensitive. Permanent adhesives such as thermosets are preferred. The receiver member 36 molded as a portion of the container 32 and the receiver member 36 welded to a portion of a surface of the container 32 is most preferred.

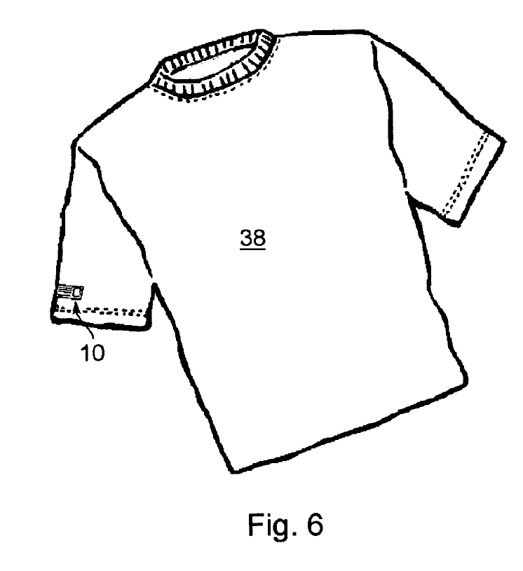

FIG. 6 is a third example of the use of an identification device 10 comprising a portion of a receiver member 36 coupled to an infant apparel article 38. The portion of the receiver member 36 is coupled to the apparel article 38 by using an adhesive or by using VELCRO® (VELCRO INDUSTRIES B.V.). As described above, a portion of the surface of the receiver member 36 defines a recess for receiving a label 22. The retainer 34 encloses the label 22 in the recess of the receiver member 36. The retainer 34 is tightly coupled to the receiver member 36 to prevent a fragile label 22 from destruction by fluids, with resulting loss of information residing on the label 22. The receiver member 36 may be of different sizes to accommodate different sizes of the label 22. In addition, the receiver member 36 and the retainer 34 may comprise flexible plastics to better conform to the shape of the apparel article 38.

In summary an identification device for an infant comprises a receiver member having a recess for receiving a label. A tightly fitting retainer encloses the label in the recess of the receiver member. The label comprises visual information to identify the infant, including the infant's name, address, parent's names, and current history of immunizations, medications and emergency telephone numbers, a photograph of the infant, a finger print and a toe print. The information may also be embedded in electronic form or as bar coded data coupled to the identification device. The identification device may be coupled to a portion of an infant's body including an arm or a leg and to an infant's possession's including drink and eating containers, apparel, foot wear, cribs and strollers.

While the invention has been particularly shown and described with reference to preferred embodiments thereof, it will be understood by those skilled in the art that the foregoing and other changes in form and details may be made therein without departing from the spirit and scope of the invention. For example, the identification device may be coupled to various kinds of infant products including toys, foot wear, cribs and strollers. The retainer may be coupled to the receiver member using hinges or the retainer and the receiver member may be an integral structure comprising sufficiently flexible plastics that allow the retainer to be bent into the receiver member.

1. An identification device for an infant comprising, in combination: an infant article; a label having a side and an opposite side, said label including personal information of the infant: and a member of the identification device, said member comprising a pair of ends, each one of said ends of said member of the identification device coupled to a portion of the infant article, said label coupled to a portion of said member of the identification device.

2. (Cancelled)

3. Amended) The identification device for an infant according to claim 1 further comprising a portion of a surface of said member of the identification device having a recess for receiving said label; and a retainer coupled to said recess of said member of the identification device enclosing said label in said recess of said member of the identification device.

4. The identification device for an infant according to claim 3 wherein said member of the identification device is curved and each one of said pair of ends of said member of the identification device is coupled to a portion of the infant article by tension.

5. The identification device for an infant according to claim 3 wherein at least a portion of said member of the identification device comprising an adhesive; a portion of said member of the identification device adhesively coupled to a portion of the infant article.

6. The identification device for an infant according to claim 4 further comprising a strap having an end and an opposite end, a portion of a first end of said member of the identification device having a slot and a portion of a second end of said member of the identification device having a slot, said slot of said first end of said member selectively receiving said end of said a strap, said slot of said second end of said member selectively receiving said opposite end of said strap so that a combination of said member of the identification device and said strap is coupled to the infant article when said end of said strap is coupled to said opposite end of said strap.

7. The identification device for an infant according to claim 6 wherein the combination of said strap of the identification device and said member of the identification device is coupled to the infant.

8. The identification device for an infant according to claim 3 wherein said label is coupled to a portion of a surface of said recess.

9. The identification device for an infant according to claim 3 wherein said label is coupled to a portion of a surface of said retainer.

10. The identification device for an infant according to claim 3 wherein a portion of said side of said label received by said recess of said member of the identification device and enclosed by said retainer comprises a visible identifier selected from the group consisting of at least a name of an infant, at least a photograph, at least a finger print and at least a toe print.

11. The identification device for an infant according to claim 3 wherein a portion of said opposite side of said label received by said recess of said member of the identification device and enclosed by said retainer comprising at least a visible list of personal information of the infant selected from the group consisting of an infant's name, at least an infant's address, at least a parent's name, a current history of immunizations, at least a medication, at least an emergency telephone number, at least a photograph, at least a finger print and at least a toe print.

12. The identification device for an infant according to claim 1 wherein at least a portion of the identification device comprises an identifier selected from the group consisting of a programmable semi-conductor chip, a digital data recording device, a radio frequency identification device and a barcode.

13. The identification device for an infant according to claim 3 wherein both said member of the identification device having said recess and said retainer of the identification device comprises transparent plastic to provide little opportunity for fluid accumulation in said recess of said member of the identification device thereby protecting said label from destruction by a fluid.

14. An integral identification device for an infant comprising, in combination: an infant article; a label coupled to a portion of the integral identification device for providing personal information of the infant; the integral identification device comprising an identification portion of the infant article, said identification portion having a recess for receiving a label; and a retainer coupled to said recess of the identification portion of the infant article for enclosing said label in said recess.

15. (Cancelled)

16. The identification device for an infant according to claim 14 wherein a portion of said label comprising a visible identifier of the infant selected from the group consisting of an infant's name, at least an infant's address, at least a parent's name, a current history of immunizations, at least a medication, at least an emergency telephone number, at least a photograph, at least a finger print and at least a toe print.

17. The identification device for an infant according to claim 14 wherein at least a portion of the identification device comprises an identifier selected from the group consisting of a programmable semi-conductor chip, a digital data recording device, a radio frequency identification device and a barcode.

18. A method for using an identifier device for an infant comprising the steps of:
providing an infant article;
providing a label having a side and an opposite side, said label including personal information of the infant and
providing a member of the identification device, said member comprising a pair of ends, each one of said ends of said member of the identification device coupled to a portion of the infant article, said label coupled to a portion of said member of the identification device.

19. The method for using an identifier device for an infant according to claim 18 further comprising the steps of:
providing a portion of a surface of said member of the identification device having a recess for receiving said label; and
coupling a retainer to said recess of said member of the identification device enclosing said label in said recess of said member of the identification device

20. The method for using an identifier device for an infant according to claim 19 further comprising the steps of: providing a portion of said side of said label received by said recess of said member of the identification device and enclosed by said retainer comprising a visible identifier selected from the group consisting of at least a name of an infant, at least a photograph, at least a finger print and at least a toe print;
providing a portion of said opposite side of said label received by said recess of said member of the identification device and enclosed by said retainer comprising at least a visible list of personal information of the infant selected from the group consisting of an infant's name, at least an infant's address, at least a parent's name, a current history of immunizations, at least a medication, at least an emergency telephone number, at least a photograph, at least a finger print and at least a toe print; and
providing at least a portion of the identification device comprises an identifier selected from the group consisting of a programmable semi-conductor chip, a digital data recording device, a radio frequency identification device and a barcode.

21. The method for using an identifier device for an infant according to claim 19 further comprising the steps of:
providing at least a portion of said member of the identification device comprises an adhesive, a portion of said member of the identification device adhesively coupled to a portion of the infant article; and
providing a strap having an end and an opposite end, a portion of a first end of said member of the identification device having a slot and a portion of a second end of said member of the identification device having a slot, said slot of said first end of said member selectively receiving said end of said strap, said slot of said second end of said member selectively receiving said opposite end of said strap so that the combination of said member of the identification device and said strap is coupled to the infant article when said end of said strap is coupled to said opposite end of said strap.
